(19) United States
(12) Patent Application Publication
(10) Pub. No.: US 2014/0272450 A1
(43) Pub. Date: Sep. 18, 2014

(54) NEAR EUTECTIC COMPOSITION NICKEL BASE SANDWICH BRAZE FOIL

(71) Applicant: Siemens Energy, Inc., Orlando, FL (US)

(72) Inventors: Kazim Ozbaysal, Orlando, FL (US); Ahmed Kamel, Orlando, FL (US)

(73) Assignee: Siemens Energy, Inc., Orlando, FL (US)

(21) Appl. No.: 14/167,159

(22) Filed: Jan. 29, 2014

Related U.S. Application Data
(60) Provisional application No. 61/782,922, filed on Mar. 14, 2013.

(51) Int. Cl. B23K 35/02

(52) U.S. Cl. CPC B23K 35/0238
USPC 428/607

(57) ABSTRACT

A braze foil (10) formed of a plurality of layers (12, 14, 16) of differing compositions wherein a combined melt of the foil has a desired braze composition, and wherein each layer is sufficiently ductile to be rolled into foil form, even though the desired braze composition is too strong or brittle to be fabricated as a foil Each interface (18,20) between layers may establish a near eutectic composition for initiating melting at the eutectic temperature, with the layer thicknesses selected so that as melting progresses away from the interfaces, the near eutectic composition is maintained within the melt puddles For certain nickel-based superalloy brazing applications, a foil having a layer of pure titanium, hafnium or zirconium may be sandwiched between respective alloy layers of 5-22% chrome-balance nickel

This application claims benefit of the 14 Mar. 2013 filing date of U.S. provisional patent application No. 61/782,922

### FIELD OF THE INVENTION

This invention relates generally to the filed of materials technology, and more specifically to a braze material useful for the repair or joining of nickel base superalloy components

### BACKGROUND OF THE INVENTION

It is recognized that the repair of superalloy materials is made difficult due to their susceptibility to weld solidification cracking and strain age cracking. The term “superalloy” is used herein as it is commonly used in the art; i e, a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g. IN 738, IN 792, IN 939), Rene alloys (e.g. Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys

Brazing processes are used to repair or to join superalloy materials in some applications While a braze joint is generally understood to be mechanically weaker than a weld joint and to have a lower acceptable operating temperature due to the relatively low melting temperature of the braze material, braze repairs may be acceptable in certain lower stress and/or lower temperature applications.

Typical braze materials using boron or silicon as the melting point depressant material are of limited value with superalloy substrate materials because they create deleterious phases which reduce the ductility of the joint and repaired region Boron and silicon free braze alloys incorporating hafnium or zirconium have been developed for which mechanical properties of up to 80% of the base superalloy properties are claimed U.S. Pat. No. 8,640,942, commonly assigned with the present application, discloses the repair of superalloy materials with titanium based, boron and silicon free braze alloys

### BRIEF DESCRIPTION OF THE DRAWINGS

The invention is explained in the following description in view of the drawings that show

FIG. 1 is a cross-sectional view of a braze foil in accordance with an embodiment of the invention

FIG. 2 is a photograph of a cross section of a braze joint made with a foil in accordance with an embodiment of the invention

### DETAILED DESCRIPTION OF THE INVENTION

The present inventors have successfully used high strength boron and silicon free braze alloys in powder form for the repair of superalloy materials However, the inventors have found that such high strength braze alloys may be difficult to fabricate as a foil because of their strength and brittleness

The sole figure illustrates a braze foil 10 which will have a desired high strength composition upon melting and which is suitable for use with superalloy materials, but which is formed as a sandwich of three layers 12, 14, 16, wherein each of the layers has a ductility sufficient to facilitate being fabricated as a foil For example, U.S. Pat. No. 8,640,942 describes near eutectic ternary alloys of Ni—Ti—Cr which are brittle in solid form, for example an alloy having a weight percentage composition of 20% Cr-20% Ti-60% Ni All composition percentages quoted herein are weight percent. In accordance with the present invention, such a composition may be formed of constituent parts which are each more ductile and more easily fabricated as a foil than the near eutectic alloy, such as when layers 12 and 16 are formed of 18-22% Cr-balance Ni, and layer 14 is formed of 100% Ti In this example, the chrome-nickel and titanium layers are relatively ductile compared to the ternary composition, and they can be rolled together to a desired thickness to form foil 10 which exhibits the desired composition upon melting The thickness of the various layers can be controlled to achieve the desired combined composition in the melted foil In one embodiment, each layer 12, 14, 16 has an equal thickness and the total thickness of the foil 10 may be less than 75 microns, although other relative and total thicknesses may be used for a particular application

Advantageously, the material of each layer is selected such that at the interfaces 18, 20 between the respective layers, the materials of the contacting layers 12/14, 14/16 diffuse and cooperate to form a desired eutectic or near eutectic composition, such that at or above the eutectic temperature, the foil 10 will begin to melt at each of the layer interfaces 18, 20. The term “near eutectic” is used herein to include any alloy having a melting temperature range of less than 25° C. Once melting is initiated, additional material from each of the layers 12/14, 14/16 contacting the puddles of melted material will add to the melt, thereby maintaining a relatively stable formulation in the puddles until the entire foil 10 is melted Accordingly, the compositions and thicknesses of the layers may be selected and manufactured in a manner that establishes a eutectic or near eutectic composition at the interfaces 18, 20 and then maintains the desired eutectic or near eutectic composition as the melt progresses.

The example of the figure includes three layers, but one skilled in the art may appreciate that other numbers of layers may be used in other embodiments so long as a desired formulation is established at each interface and is maintained as the layers melt For example, a two-layer foil may be formed by joining a layer of chrome-nickel alloy against a layer of pure titanium, hafnium or zirconium, such as may be envisioned by layers 14 and 16 alone of the figure Such a foil may be useful for filling minor surface cracks in a superalloy substrate by disposing the foil, alloy side down, on top of the substrate surface, then heating the assembly to melt the foil, thereby at least partially filling the cracks and recreating a crack-free surface.

Generally, pure metal layers tend to be more ductile than alloys of the metal, so for ternary alloys it may be useful to provide a middle layer 14 as a pure metal and to have an alloy of two other metals as top and bottom layers 12, 16. For example, a boron and silicon free braze alloy sandwich foil may be formed with layers 12 and 16 being Cr—Ni and layer 14 being titanium or hafnium or zirconium. When such a foil is used to braze two adjoined nickel-based superalloy substrates, the chrome-nickel layers are in contact with the superalloy substrates as the heating and melting progresses. Advantageously, this avoids contact between the pure metal layer and the superalloy substrates which might otherwise tend to form undesirable intermetallic compounds during the heating and melting process.

In one embodiment, shown in the photograph of FIG. 2, a three-layer foil 10 has been used to braze together two alloy 247 substrates such as may form portions of a gas turbine engine component. Alloy 247 is known to have a nominal weight percent composition of 8 3 Cr, 10 Co, 0.7 Mo, 10 W, 5 5 Al, 1 Ti, 3 Ta, 0 14 C, 0 015 B, 0.05 Zr and 1.5 Hf, balance Ni In this embodiment, prior to the melt, each of layers 12 and 16 were 20% Cr-balance Ni, and layer 14 was 100% Ti, and each layer had a nominal thickness of 25 microns. The foil and substrates were then heated to 1,230° C. for 12 hours and then cooled to form the joint shown in FIG. 2 The thickness of the braze joint is somewhat less than the 75 micron thickness of the unmelted foil 10 In other embodiments, the two Cr—Ni layers 12, 16 may be in the range of 5-22% chrome, and the middle layer 14 may be titanium or another melting temperature suppressing material such as hafnium or zirconium

While various embodiments of the present invention have been shown and described herein, it will be obvious that such embodiments are provided by way of example only Numerous variations, changes and substitutions may be made without departing from the invention herein. Dimensions and compositions should be understood to be subject to typical manufacturing tolerances. For example, a composition expressed as a percentage will typically be understood to be within ±0 5% of the stated value, and “pure” is understood to include some trace impurities of inconsequential functional result.

The invention claimed is:

1. A braze foil comprising:
top and bottom layers each comprising a chrome-nickel alloy; and
a middle layer of pure metal disposed between the top and bottom layers

2. The braze foil of claim 1, wherein the middle layer is titanium.

3. The braze foil of claim 1, wherein the middle layer is hafnium

4. The braze foil of claim 1, wherein the middle layer is zirconium

5. The braze foil of claim 1, wherein the top and bottom layers each comprise an alloy having a composition of 5-22% Cr-balance Ni

6. The braze foil of claim 1, further comprising
each of the top and bottom layers is 20% Cr-balance Ni; and
the middle layer is 100% Ti.

7. The braze foil of claim 6, wherein each of the top, middle and bottom layers has a nominal thickness of 25 microns

8. The braze foil of claim 1, further comprising a composition of the top and bottom layers selected to form a near eutectic alloy at respective interfaces with the middle layer.

9. A braze foil comprising:
a layer of chrome-nickel alloy, and
a layer of a pure metal disposed against the layer of chrome-nickel alloy, wherein the pure metal is selected from the group of titanium, hafnium and zirconium

10. The braze foil of claim 9, further comprising the chrome-nickel alloy having a composition effective to form a near eutectic alloy at an interface with the layer of pure metal

11. The braze foil of claim 9, wherein the layer of chrome-nickel alloy is a first layer of chrome-nickel alloy, and further comprising a second layer of chrome-nickel alloy disposed against a side of the layer of pure metal opposed the first layer of chrome-nickel alloy

12. The braze foil of claim 9, wherein the layer of pure metal is titanium

13. The braze foil of claim 9, wherein the layer of pure metal is hafnium

14. The braze foil of claim 9, wherein the layer of pure metal is zirconium.

15. The braze foil of claim 9, wherein the layer of chrome-nickel alloy has a composition of 5-22% Cr-balance Ni.
